(19) United States
(12) Patent Application Publication
(10) Pub. No.: US 2023/0322592 A1
(43) Pub. Date: Oct. 12, 2023

(54) Removal of Per- and Polyfluoroalkyl Substances (PFAS) from Water

(71) Applicant: CDM Smith Inc., Boston, TX (US)

(72) Inventors: Dung Duc Nguyen, Bellevue, WA (US); Charles Edward Schaefer, Edison, NJ (US)

(21) Appl. No.: 18/194,697

(22) Filed: Apr. 3, 2023

Related U.S. Application Data
(60) Provisional application No. 63/328,834, filed on Apr. 8, 2022.

(51) Int. Cl. C02F 1/58

(52) U.S. Cl. CPC C02F 1/58; C02F 2101/36

(57) ABSTRACT

Method of removing of per- and polyfluoroalkyl substances (PFAS) from water are described. The methods involve sparging a gas into a container of water; and collecting an aerosol released in a volume above the water.

### RELATED APPLICATION

This application claims the benefit of U.S. Provisional Application No. 63/328,834, filed on Apr. 8, 2022. The entire teachings of the above application are incorporated herein by reference.

### BACKGROUND

Per- and polyfluoroalkyl substances (PFAS) are stable, persistent compounds that bioaccumulate in the environment. They are found in drinking water supplies, food products, and the blood of people and animals all over the world. PFAS are associated with a variety of human health risks. PFAS are stable and unreactive, and therefore are difficult to separate and remove from bulk water supplies.

### SUMMARY

Current methodologies for removing per- and polyfluorinated substances (PFAS) from water involve sparging a water column to create a foam. The foam is collected and removed or, alternatively, the top portion of the water column is collected and removed. An implicit assumption is that the PFAS concentrate in the foam and the top portion of a water column.

The inventors have discovered that sparging a water column contaminated with PFAS can cause the PFAS to become aerosolized above the water column. The methods described herein involve collection and/or removal of the aerosol, as opposed to collection and/or removal of the foam or top portion of the water column, in order to remove the PFAS and thereby reduce the concentration of PFAS in the water source.

The methods described herein take advantage of the high surface area-to-volume ratio of the bubbles to remove PFAS from the bulk solution. The methods can be used to remove PFAS from waters that do not foam readily, such as waters with relatively low PFAS (<1,000 ng/L) concentrations, which can be very common. The very low volume of aerosols generated and collected in a single stage treatment reduces the need for multi-stage treatment. The methods described herein can reduce the need for subsequent steps to reduce water volume and concentrate the PFAS, thereby reducing complexity and cost of removing PFAS from water compared to existing foam fractionation methods.

Described herein are methods of removing of per- and polyfluoroalkyl substances (PFAS) from water. The methods involve sparging a gas into a container of water; and collecting an aerosol released in a volume above the water.

Collecting an aerosol released in the volume above the water can include positioning an adsorbent or absorbent above the volume above the water to collect the aerosol. In some instances, the adsorbent or absorbent can be cleaned and recycled.

Collecting an aerosol released in the volume above the water can include flowing a gas across the volume above the water to collect the aerosol in a secondary chamber, optionally by collecting the aerosol on an adsorbent or absorbent material within the secondary chamber, optionally by condensing the aerosol in the secondary chamber.

Sparging the gas can include flowing the gas through a diffuser, such as a diffuser having an average pore size from about 1 μm to about 100 μm to generate an aerosol having an average particle size from about 1 μm to about 100 μm.

Sparging the gas in the container of water can include pneumohydraulic sparging, or delivering gas by miniature axisymmetric supersonic nozzles, or cavitation tube sparging.

In some instances, less than 1% of the water is removed. Typically, a foam is not collected.

In some instances, a surfactant can be added to the water.

Many PFAS can be removed, such as perfluorooctane sulfonic acid (PFOS), perfluorooctanoic acid (PFOA), perfluorohexane sulfonic acid (PFHxS), perfluorohexanoic acid (PFHxA), and perfluorobutane sulfonic acid (PFBS).

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIGS. 1A-B are schematics of embodiments of an apparatus for removing per- and polyfluoroalkyl substances from water.

FIG. 2 is a chart showing the concentration of five perfluoroalkyl acids (PFAAs) at three sampling intervals (time in minutes).

FIG. 3 is a chart showing PFAS mass balance for five perfluoroalkyl acids.

### DETAILED DESCRIPTION

A description of example embodiments follows.

### Perfluorinated and Polyfluorinated Substances

Per- and polyfluoroalkyl substances (PFAS) are fluorinated organic compounds. Perfluoroalkyl substances are organic compounds in which all carbon-hydrogen bonds have been substituted with carbon-fluorine bonds. Polyfluorinated substances are organic compounds in which at least one carbon-hydrogen bond and carbon-fluorine bond exists. In the past, PFAS have been referred to as per- and polyfluorinated chemicals (PFCs). In general, the methods described herein are useful for removing fluorine-containing surface active compounds.

PFAS can be divided into polymeric and non-polymeric PFAS, and as used herein the term PFAS broadly includes both. Representative classes of polymeric PFAS include fluoropolymers, side-chain fluorinated polymers, and perfluoropolyethers. Representative classes of non-polymeric PFAS include perfluoroalkyl acids (PFAAs), perfluoroalkane sulfonyl fluoride (PASF), PASF-based derivatives, perfluoroalkyl iodides (PFAIs), fluorotelomer iodoes (FTIs), fluorotelomer-based derivatives, and per- and polyfluoroalkyl ethers (PFPEs)-based derivatives.

In general, PFAS are used to make fluoropolymer coatings and products that resist heat, oil, stains, grease, and water. There are thousands of PFAS compounds, which are found in many different consumer, commercial, and industrial products. Perfluorooctane sulfonic acid (PFOS) and perfluorooctanoic acid (PFOA) are two of the most frequently detected in humans. Others include perfluorohexane sulfonic acid (PFHxS), perfluorohexanoic acid (PFHxA), perfluorobutane sulfonic acid (PFBS), and perfluorononanoic acid (PFNA). Other classes of PFAS include, for example, perfluoroether carboxylic acids (e.g., hexafluoropropylene oxide dimer acid (HFPO-DA) fluoride), perfluoro sulfonamide-based compounds (perfluorooctane sulfonamide), fluorotelomer sulfonates, and polyfluorinated phosphate esters.

The fluorine-carbon bonds are extremely stable and confer these substances with very high thermal and chemical stability. Many are hydrophobic and/or oleophobic. Since the compounds are so stable, they are persistent and bioaccumulate in the environment. They can be found in water, air, and soil, and can also be found in numerous fish, animals, and plants that inhabit contaminated areas. PFAS can be found in drinking water supplies, food products, and the blood of people and animals all over the world. PFAS are associated with a variety of human health risks. For this reason, removal of PFAS from drinking water supplies is desirable.

PFAS are found in many sources of water, including groundwater, surface water, leachate, filtration concentrates, wastewater (municipal and industrial), rainwater, porewater, and other aqueous streams.

Existing Methods for Removal of PFAS from Water

Existing foam fractionation methods for removing PFAS from impacted water sources involve accumulation and/or concentration of PFAS at or near the top of a water column by sparging a water column. The PFAS are believed to accumulate in a foam phase above the water level or to concentrate in the bulk aqueous phase near the top of a water column. The foam is collected or condensed and/or the top portion of the water column (e.g., top 10% of the water column) is collected.

Existing foam fractionation methods typically involve a multi-stage, sequential treatment approach, in which the collected foam and/or water is passed to a secondary treatment phase where the foregoing process is repeated. A tertiary treatment step can also be performed to further concentrated the PFAS and reduce the volume of PFAS-impacted water.

Removal of PFAS from the water column in existing foam fractionation methods is ultimately based upon a perceived accumulation of PFAS in the foam and/or an increase in the concentration of dissolved PFAS near the top of the water column. In addition, the concentration of PFAS from the water volume, and the associated volume reduction, is dependent upon the collection and condensing of the collected foam, and/or the removal of water from the top of the water column via displacement using PFAS-free water. Methods that involve collecting the top portion of the water column can involve collection of a significant volume of water, particularly when large volumes of water are treated (e.g., for municipal water supply).

Removal of PFAS from Water By Collecting Aerosols

An aerosol is a suspension of fine particles dispersed in a gas. Aerosol typically have an approximate particle diameter from 1 to 100 μm, but diameters outside of this range fall with embodiments described herein.

The inventors have discovered that sparging water contaminated with PFAS forms an aerosol of PFAS suspended in the gas (typically air) above the water. The methods described herein remove PFAS from water by collecting the aerosol that forms above the water, resulting in increased collection of PFAS and collection of a smaller volume of PFAS-rich water compared to collection of the foam and/or top portion of the water column. Reducing the volume of water collected reduces the volume of waste water that must be disposed of, which significantly reduces cost and complexity.

Some PFAS-containing water sources are less-susceptible to foaming than others, and for this reason removal of PFAS from these water sources by foam fractionation methods has been challenging. Whether or not sparging a water source will generate a foam depends on several factors relating to the water source (e.g., the concentration of PFAS, the chemical composition of the PFAS, and the concentration and type of organic content, with lower concentrations of organic content less likely to foam), and the process conditions (e.g., how vigorously the water is aerated/sparged, which in turn depends on air flow rate, pore size of the diffuser, and whether an anti-foaming agent has been added). In general, ground water and drinking water are less likely to foam. The methods described herein are particularly useful for removing PFAS from water that does not readily foam.

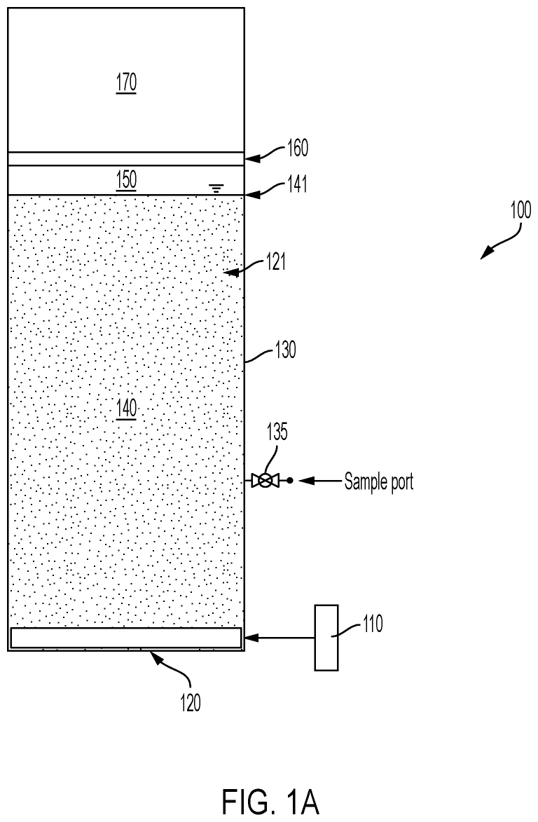

FIGS. 1A-B are schematics of embodiments of an apparatus for removing per- and polyfluoroalkyl substances from water. FIG. 1A is an embodiment in which an aerosol is captured by an adsorbent. FIG. 1B is an embodiment in which an aerosol is swept away by a flow of gas.

A source of compressed gas 110 provides a flow of gas into a diffuser 120, which is positioned at or near the bottom of a holding tank 130. Flowing gas into the diffuser 120 generate fine bubbles 121 throughout the holding tank 130. The source of compressed gas 110 is typically compressed air, but other compressed gasses can be used, such as nitrogen or noble gases such as helium or argon. Optionally, the holding tank 130 includes a sample port 135.

As the bubbles rise through the water 140, they generate abundant air-water interfaces that facilitate the interfacial sorption of PFAS. Once these PFAS-enriched bubbles reach the water surface 141, aerosols are formed and released from the water column into the volume 150 above the water surface 141. These aerosols are greatly enriched in PFAS due to the high interfacial area-to-volume ratio of bubbles. The concentration of PFAS within the aerosol depends on a variety of factors, such as concentration of PFAS in the water, the chemical composition of the PFAS in the water, the pore size of the diffuser, the air flow rate through the diffuser, and the duration of time that the method is performed.

The diffuser 120 is typically a fine bubble diffuser, which can be used to generate bubbles having an approximate average diameter ranging from 1 μm and 1000 μm though oftentimes from the approximate average diameter ranges from 1 μm to 100 μm or from 20 μm to 50 μm. The bubble size can fluctuate and typically decreases as bubbles rise to the surface of the tank. The precise size of the bubbles that are generated depends on several factors, including the temperature of the water, the pressure and flow rate of the gas from the compressed gas source, the pore size of the diffuser, and the height of the water column. Diffusers can be made from ceramic, metal, plastic, or other materials. The holding tank 130 can be a water column, chemical reactor, or any other liquid holding tank.

Next, the aerosols are removed before the suspended PFAS fall back into the water or condense along the interior walls of the vessel 140. In the embodiment of FIG. 1A, the aerosols are captured by an adsorbent (or absorbent) 160 placed above the tank 130. Many adsorbents are known, and one type of suitable adsorbent is a perforated adsorbent. Section 170 can include a mechanism for holding the adsorbent (or absorbent) 160 in place, which in some embodiments can be a simple weight. In the embodiment of FIG. 1B, a flow of gas enters through an inlet and exits through an outlet to sweep away the aerosols from within the volume 150 into a secondary chamber 180, within which the aerosols are condensed and/or captured on a adsorbent (or absorbent) material. Suitable sorbent materials include sorbent mats, carbon-based materials, or other material designed for capturing/condensing the aerosols and retaining the PFAS. Following treatment, the sorbent 160 can be disposed of or treated, and the water 140 remaining in the water column 130 can be reused, recycled, or discharged appropriately. The volume of water removed via aerosolization is typically small (less than 0.01%) relative to the volume of treated water in the water column 130. The embodiments of FIGS. 1A and 1B can be combined such that an adsorbent or absorbent is affixed above the area for the gas inlet and outlet to capture any aerosols that are not swept away by the flow of gas.

Other embodiments involve alternate sparging methods. In one embodiment, diffusers are placed along the side of the vessel, and in some embodiments diffusers are placed at different heights along the side of the vessel. In another embodiment, pneumohydraulic spargers can be used to introduce bubbles. In another embodiment, miniature axisymmetric supersonic nozzles are used to provide high-pressure gas delivery. In another embodiment, cavitation tube sparging can be used to generate fine bubbles.

In some embodiments, surfactants are added to the water 140 to increase sorption of PFAS at the air-water interface. These can be in the form of cationic, anionic, or nonionic surfactants to modify the surface charge of the bubbles to remove PFAS that otherwise have a poor affinity to the air-water interface.

The methods described herein can be applied to a variety of PFAS-impacted water (e.g., groundwater, surface water, leachate, wastewater, filtration concentrates) including those that do not foam readily. In addition, these methods can reduce complexity and cost relative to existing foam fractionation methods that rely on multi-staged, sequential removal and concentration of PFAS. The methods described herein can remove PFAS from impacted water in a single stage.

### EXEMPLIFICATION

An experiment was performed in a 45-L reactor filled with deionized water spiked with 1,000 nanograms per liter (ng/L) of each of five perfluoroalkyl acids: perfluorohexanoic acid (PFHxA), perfluorooctanoic acid (PFOA), perfluorobutanesulfonic acid (PFBS), perfluorohexanesulfonic acid (PFHxS), and perfluorooctanesulfonic acid (PFOS). An air flow rate of approximately 120 standard cubic feet per hour (SCFH) was introduced through a 6-inch diameter fine bubble, ceramic diffuser disc (capable of generating bubbles with an average diameter ranging between 20 and 50 microns) placed at the bottom of the reactor to facilitate aerosolization. An ⅛-inch thick, 3-plied, polypropylene adsorbent mat, of the type typically used to address liquid spills in laboratory settings, was placed at the top of the reactor, at approximately two inches above the top of the water surface, to capture aerosols generated. Samples were collected at a sample port placed a third of the way from the bottom of the column at 0, 15, and 60 minutes following the start of aeration to aid in evaluating perfluoroalkyl acid (PFAA) removal as a function of time. Upon completion of the experiment, an eighth of the sorbent mat was collected and sent to a laboratory for PFAS analysis by liquid chromatography with tandem mass spectrometry (LC-MS-MS) and in accordance with the United States Department of Defense Quality Systems Manual, Version 5.1, Appendix B, Table B-15). To determine the PFAS mass balance evaluation, the volumes and PFAS concentrations were manually recorded and analytically measured, respectively, before and after treatment to determine PFAS mass removed as a result of the treatment.

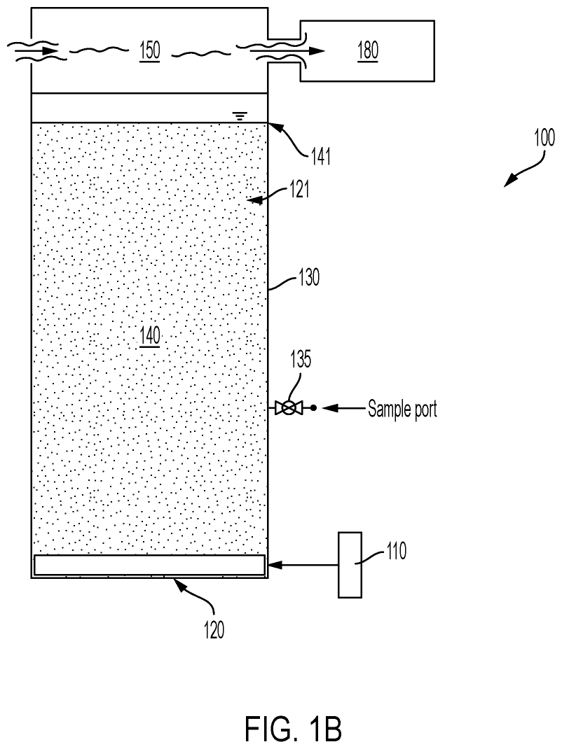

As shown in FIG. 2, significant removal of PFOS and PFOA, both of which are considered long-chained PFAAs, was observed. In general, longer-chain PFAAs were removed more effectively than shorter-chain PFAAs. Short-chained perfluorinated carboxylates (PFCAs) refers to those with 4 to 7 carbons whereas short-chained perfluorinated sulfonates (PFSA) refers to PFAAs with 4 to 5 carbons. See generally OECD (2013), OECD/UNEP Global PFC Group, Synthesis paper on per- and polyfluorinated chemicals (PFCs), Environment, Health and Safety, Environment Directorate, OECD. In addition, PFSAs including PFBS, PFHxS, and PFOS were removed more effectively than PFCAs including PFHxA and PFOA; this is consistent with their air-water interfacial adsorption coefficients reported in literature. See Charles E. Schaefer et al., “Uptake of Poly- and Perfluoroalkyl Substances at the Air—Water Interface,” Environ. Sci. Technol. 2019, 53, 21, 12442-12448.

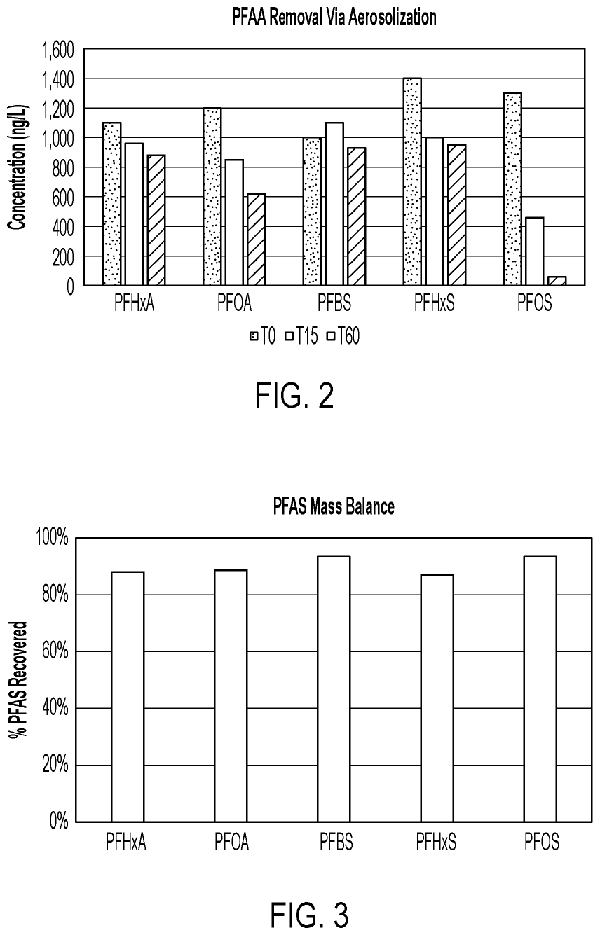

A PFAS mass balance was performed to evaluate the initial PFAS mass (i.e., volume multiplied by concentration) added to the reactor, the PFAS mass observed in the bulk solution after the experiment, and the PFAS mass on the sorbent mat after the experiment. FIG. 3 shows very good PFAS mass recovery, from approximately 85% to approximately 95%, for all PFAAs tested.

### INCORPORATION BY REFERENCE; EMBODIMENTS

The teachings of all patents, published applications, and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A method of removing of per- and polyfluoroalkyl substances (PFAS) from water, the method comprising:
a) sparging a gas into a container of water; and
b) collecting an aerosol released in a volume above the water.

2. The method of claim 1, wherein collecting an aerosol released in the volume above the water comprises positioning an adsorbent or absorbent above the volume above the water to collect the aerosol.

3. The method of claim 2, further comprising cleaning and recycling the adsorbent or absorbent.

4. The method of claim 1, wherein collecting an aerosol released in the volume above the water comprises flowing a gas across the volume above the water to collect the aerosol in a secondary chamber.

5. The method of claim 4, further comprising collecting the aerosol on an adsorbent or absorbent material within the secondary chamber.

6. The method of claim 4, further comprising condensing the aerosol in the secondary chamber.

7. The method of claim 1, wherein sparging the gas comprises flowing the gas through a diffuser.

8. The method of claim 7, wherein the diffuser has an average pore size from about 1 μm to about 100 μm.

9. The method of claim 1, wherein the aerosol has an average particle size from about 1 μm to about 100 μm.

10. The method of claim 1, wherein sparging the gas in the container of water comprises pneumohydraulic sparging.

11. The method of claim 1, wherein sparging the gas in the container of water comprises delivering gas by miniature axisymmetric supersonic nozzles.

12. The method of claim 1, wherein sparging the gas in the container of water comprises cavitation tube sparging.

13. The method of claim 1, wherein less than 1% of the water is removed.

14. The method of claim 1, wherein a foam is not collected.

15. The method of claim 1, further comprising adding a surfactant to the water.

16. The method of claim 1, wherein the PFAS is perfluorooctane sulfonic acid (PFOS).

17. The method of claim 1, wherein the PFAS is perfluorooctanoic acid (PFOA).

18. The method of claim 1, wherein the PFAS is perfluorohexane sulfonic acid (PFHxS).

19. The method of claim 1, wherein the PFAS is perfluorohexanoic acid (PFHxA).

20. The method of claim 1, wherein the PFAS is perfluorobutane sulfonic acid (PFBS).
